(19) United States
(12) Patent Application Publication
(10) Pub. No.: US 2025/0312956 A1
(43) Pub. Date: Oct. 9, 2025

(54) METHOD FOR MANUFACTURING A PRE-MOLDING AND/OR A RADOME FOR RADAR DEVICES FOR VEHICLES

(71) Applicant: OECHSLER AG, Ansbach (DE)

(72) Inventors: Stefan Kronberger, Ansbach (DE); Steffen Neumann, Gerolfingen (DE); Dominik Woerlein, Wolframs-Eschenbach (DE)

(21) Appl. No.: 19/170,632

(22) Filed: Apr. 4, 2025

(30) Foreign Application Priority Data
Apr. 4, 2024 (DE) 102024109457.5

(51) Int. Cl. B29C 45/14; B29L 31/34; H01Q 1/42

(52) U.S. Cl. CPC B29C 45/14639; B29L 2031/3456; H01Q 1/42

(57) ABSTRACT

In one aspect, a method for manufacturing a pre-molding and/or a radome for radar devices for vehicles includes forming a pre-molding having at least one contact element for electrically contacting a heating unit for heating the radome. When forming the pre-molding, the at least one contact element is at least partially overmolded with plastic.

### CROSS-REFERENCE TO RELATED APPLICATIONS

The present application is based upon and claims the right of priority to German Patent Application No. 10 2024 109 457.5, filed Apr. 4, 2024, the disclosure of which is hereby incorporated by reference herein in its entirety for all purposes.

### FIELD OF THE INVENTION

The present subject matter relates to a method for manufacturing a pre-molding and/or a radome for radar devices for vehicles, in which a pre-molding having at least one contact element for electrically contacting a heating unit for heating the radome is formed.

### BACKGROUND OF THE INVENTION

DE 101 56 699 A1 discloses a method for manufacturing a radome.

### SUMMARY OF THE INVENTION

In various aspects the problem(s) of the prior art is/are addressed by the present subject matter by providing an improved method for manufacturing a pre-molding and/or a radome.

Specifically, in various aspects, the problem(s) of the prior art is/are addressed by using a method for manufacturing a pre-molding, a pre-molding, a radome, and/or a radar device having the features described and claimed herein. Advantageous or preferred embodiments are the subject matter of one or more of the claims presented herein.

In one aspect, the present subject matter relates to a method for manufacturing a pre-molding and/or a radome for radar devices for vehicles. The radome is therefore a vehicle radome. The radome acts as a cover for the radar device. The pre-molding is a semi-manufactured product which is used to produce the radome.

In the method, a pre-molding having at least one contact element for electrically contacting a heating unit for heating the radome is formed.

In order to form the pre-molding, the at least one contact element is at least partially overmolded with plastic. This protects the contact element from environmental influences and mechanical damage. Simultaneously, a fixed anchoring of the contact element in the pre-molding is ensured, which improves the structural integrity of the system. Additionally or alternatively, the pre-molding, in which the at least one contact element is located, is formed in one method step. The at least one contact element no longer needs to be added in a subsequent step.

In an advantageous development of the present subject matter, the at least one contact element is overmolded such that it extends from an outer face of the pre-molding to an inner face of the pre-molding. This facilitates the electrical connection of components to the at least one contact element without impairing the structure of the pre-molding. The continuous arrangement also improves the mechanical stability of the contact element inside the pre-molding.

It is advantageous when the at least one contact element is inserted, in particular interlockingly, into a first injection mold. As a result, a precise positioning of the contact element in the pre-molding is made possible, which simplifies the assembly and increases the manufacturing accuracy. The interlocking insertion also prevents the contact element from moving during the injection molding process, which results in higher quality.

Moreover, it is advantageous when at least one retaining extension of the at least one contact element is arranged in a recess provided therefor in the first injection mold. This additionally secures the contact element in the mold and prevents deformations or damage from occurring during the overmolding. In addition, this arrangement allows the contact element to be more exactly aligned, which improves the efficiency of the electrical connection.

Advantageously, the at least one contact element is overmolded such that at least one contact region remains free of the plastic in at least some regions, which plastic forms the pre-molding. Additionally or alternatively, it is advantageous when the at least one contact element is overmolded such that at least one connection region remains free of the plastic in at least some regions, which plastic forms the pre-molding. As a result, the contact region, which is essential for the electrical function, and/or the connection region of the contact element is kept accessible. As a result, the pre-molding requires no post-processing or only a small amount of post-processing.

In addition, it is advantageous when the at least one contact element is ovemolded such that an inner element face of the at least one contact element is overmolded at least in some regions, which inner element face includes the connection region. Due to the overmolding of certain regions, additional insulation and protection against mechanical effects are achieved without adversely affecting the functionality of the connection region. Additionally or alternatively, as a result, improved stability of the at least one contact element and of the ovemolded plastic can be achieved.

According to an advantageous development of the present subject matter, the at least one contact element is overmolded such that, on the inner element face, a recess is formed in the plastic forming the pre-molding so that the connection region remains free. The recess can be preferably arranged between two retaining extensions. This specific recess allows for unobstructed access to the connection region for an electrical contacting with the connection region.

It is advantageous when the at least one contact element is overmolded such that an outer element face of the at least one contact element remains free of plastic at least in some regions, which outer element face includes the contact region. The at least one contact element can be overmolded such that the outer element face remains completely free of plastic. This design facilitates the electrical connection to external components by ensuring direct access to the contact region. Moreover, as a result, the contact region no longer requires post-processing. For example, the contact region no longer needs to be freed of plastic in order to remove the insulation formed by the plastic.

It is advantageous when a second injection mold is placed flat on the contact region during overmolding. This precise placement of the mold ensures that the surface of the pre-molding will be even, which improves the aerodynamic properties and optimizes the appearance. Additionally or alternatively, as a result, the contact region remains free of plastic so that post-processing is no longer necessary, for example, to expose the contact region.

According to the present subject matter, the at least one contact element is overmolded with the plastic such that an outer face of the pre-molding and the at least one contact region form an, in particular level, surface and/or a smooth and/or stepless transition. This enables the contact element to be seamlessly integrated into the pre-molding, which, for example, also improves a visual appearance of the radome. In addition, as a result, as is explained in greater detail in the following, a heating unit, in particular a heating wire, can be placed over the stepless transition between the contact element and the pre-molding without the need to overcome projections.

It is advantageous when the at least one contact element is overmolded such that the retaining extension extending away from the inner element face extends out of the pre-molding. Due to the projection of the retaining extension, a robust mechanical anchoring of the contact element in the pre-molding is ensured, which increases the mechanical stability and reliability of the contact element.

It is also advantageous when the plastic is injected at least partially onto a peripheral element face of the at least one contact element. The partial overmolding offers specific protection of the contact element against environmental influences and mechanical loads without adversely affecting the electrical accessibility. In addition, as a result, the at least one contact element can be connected to the plastic and thus to the pre-molding in a more stable manner.

It is advantageous when the at least one contact element is overmolded such that it is interlockingly connected to the pre-molding at least on the inner element face. An interlocking connection improves the mechanical strength of the unit including the contact element and the pre-molding.

It is also advantageous when the at least one contact element is overmolded with the plastic such that an inner face of the pre-molding, which is located on the side of the pre-molding facing away from the outer face, and the at least one connection region are spaced apart from one another, the at least one connection region preferably being offset relative to the inner face. As a result, a step down (e.g., a completely peripheral, step down) towards the connection region forms. The connection region is therefore located in a recess, with the connection region being bordered by the plastic. As a result, for example, a contact pin can be pressed onto the connection region, which contact pin can be prevented, due to the recess, from sliding laterally away from the connection region.

It is advantageous when at least one heating unit for heating the radome is located on the pre-molding, in particular on the outer face. The heating unit can be a heating wire. Locating the heating unit on the outer face of the pre-molding makes it possible to efficiently heat the radome. The use of a heating wire offers the advantage of uniformly distributing heat over a radome surface.

It is advantageous when the heating unit is contacted with the at least one contact region, in particular with two contact regions, which are preferably electrically insulated from each other. Due to the electrical connection of the heating unit with the at least one contact region, a reliable power supply to the heating unit is ensured.

It is advantageous when the heating unit is connected to the pre-molding, in particular embedded in the pre-molding, by means of ultrasonic welding. In particular, the heating wire can be embedded in the pre-molding by means of ultrasonic welding. Ultrasonic welding enables a fixed and permanent connection between the heating unit and the pre-molding, which improves the mechanical integrity and reliability of the overall construction. Embedding the heating unit in the pre-molding additionally protects the heating unit against mechanical damage and environmental influences, which extends the service life of the system. The embedding of the heating unit, or of the heating wire, and the placement of the heating unit, or of the heating wire, can be advantageously carried out at the same time. When the heating wire is placed down onto the pre-molding, the heating wire is simultaneously embedded by means of the ultrasonic welding.

It is also advantageous when the heating unit is contacted with the at least one connection region by means of thermocompression welding. Thermocompression welding offers a top-quality conductive connection between the heating unit and the connection contact, which enables an efficient energy transmission and thus an optimal heat output.

It is advantageous when a casing, in particular a bonding varnish, is removed when the heating unit is contacted with the at least one contact region by means of thermocompression welding. This improves the electrical connection between the heating unit and the contact region by enabling a direct metal-to-metal connection, which increases the electrical conductivity and the reliability of the connection. Removing the casing also contributes to minimizing the resistance losses, which increases the efficiency of the heating unit.

Furthermore, it is advantageous when the heating wire is arranged on the pre-molding, in particular on the outer face, in a meandering pattern. Due to the placement of the heating wire in a meandering pattern, heat is distributed uniformly over the entire surface of the radome, which improves the efficacy of the heating system.

It is advantageous when the pre-molding and the heating unit are overmolded, so that the pre-molding and the heating unit are surrounded by a protective casing. Overmolding with a protective casing offers additional protection against environmental influences and mechanical damage, which increases the service life and reliability of the overall system.

It is advantageous when the pre-molding is initially formed by overmolding the at least one contact element with the plastic. Additionally or alternatively, it is advantageous when the heating unit is then arranged on the pre-molding. Additionally or alternatively, it is advantageous when the heating unit is then connected to the pre-molding. Additionally or alternatively, it is advantageous when the heating unit is then connected to the at least one contact element. Additionally or alternatively, it is advantageous when the pre-molding and the heating unit are then overmolded with the protective casing. This sequential production process enables the components to be efficiently formed and/or integrated, in which process each method step follows the preceding method step, which reduces the production time and production costs. The step-by-step method also enables quality control to be carried out at each point in time of the process, which ensures the quality of the final product.

It is advantageous when two contact elements are overmolded with the plastic, which contact elements are preferably spaced apart from one another. The use of two contact elements allows for a more flexible connection of the heating unit and improves the power supply to the heating unit by allowing for a redundant or differentiated activation. The spatial separation of the contact elements insulates the two contacts elements from each other. The two contact elements each have a contact region and a connection region. Moreover, the two contact elements can be identical to each other.

It is advantageous when the heating unit is contacted by two contact regions, which, in particular, are electrically insulated from each other. As a result, a circuit can be formed through the heating unit in order to enable heat to be generated.

It is advantageous when the at least one contact element is a punched and/or bent part. For example, the at least one contact element can be punched out and/or bent. As a result, a highly cost-effective manufacturing of the at least one contact element can be achieved.

It is advantageous when the at least one contact element is punched out of metal and/or out of a sheet. As a result, the contact element has electrical conductivity in order to be able to supply the heating unit with electrical energy.

The present subject matter further relates to a pre-molding, which is manufactured according to one or more method features of the preceding description and/or the following description.

The present subject matter also relates to a radome, which is manufactured according to one or more method features of the preceding description and/or the following description.

The present subject matter also relates to a radar device, which includes a radome having one or more feature(s) of the preceding description and/or the following description. Additionally or alternatively, the radome of the radar device can also be manufactured according to one or more method features of the preceding description and/or the following description.

### BRIEF DESCRIPTION OF THE FIGURES

Further advantages of the invention are described in the following exemplary embodiments. Wherein:

FIG. 1 shows a perspective view of an inner face of a pre-molding,

FIG. 2 shows a perspective view of a detail of the inner face of the pre-molding,

FIG. 3 shows a perspective view of an outer face of a pre-molding,

FIG. 4 shows a perspective view of a contact element,

FIG. 5 shows a cross-section through the pre-molding and the contact element,

FIG. 6 shows a cross-section through the pre-molding, the contact element, and two injection molds,

FIG. 7 shows a perspective view of an outer face of a pre-molding, on which a heating unit is located, and

FIG. 8 shows a cross-section through the pre-molding, two contact elements, a heating unit, and a protective casing.

### DETAILED DESCRIPTION

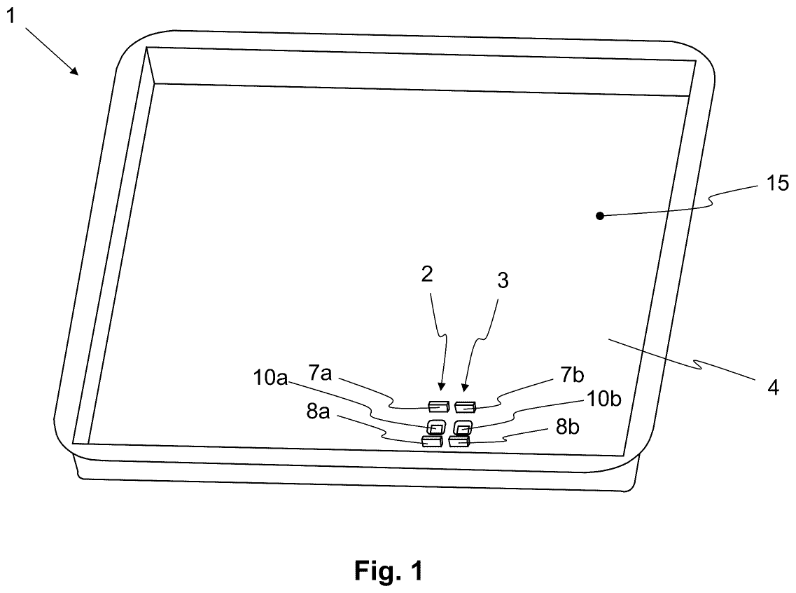

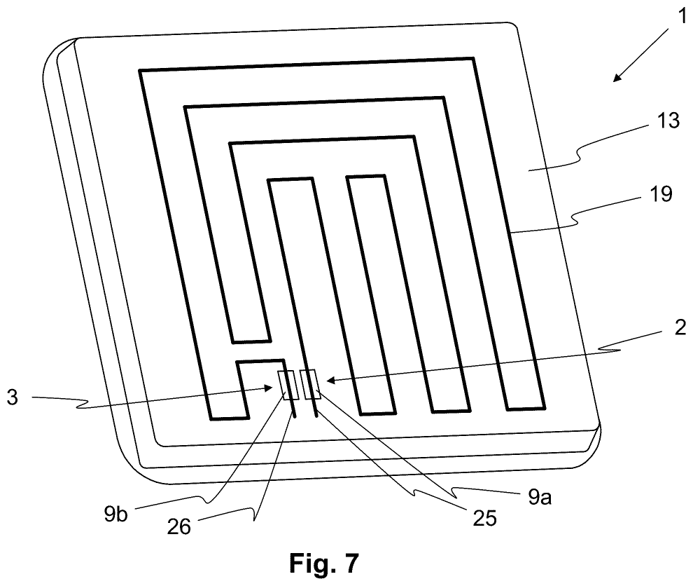

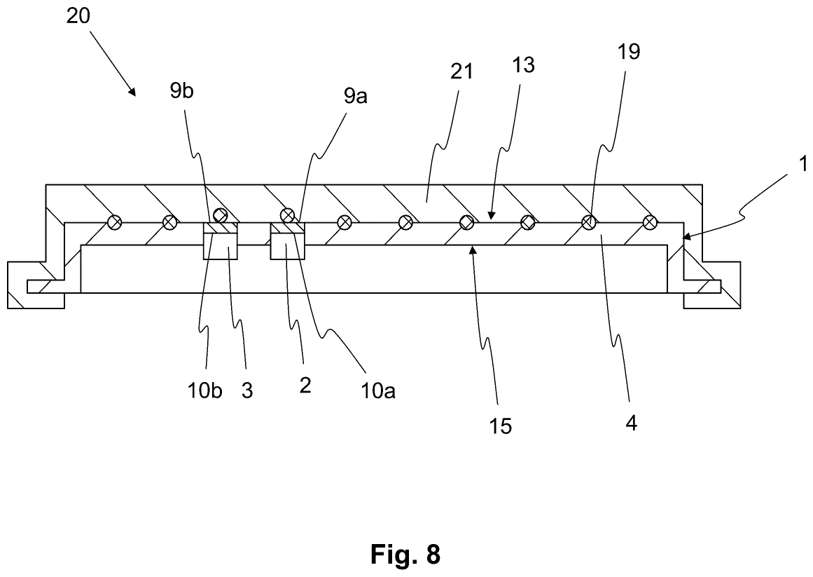

FIG. 1 shows a perspective view of an inner face 15 of a pre-molding 1. The pre-molding 1 can be used to manufacture a radome 20 for a radar device. The radome 20 is shown at least in part in FIG. 8. The radome 20 acts as a cover for the radar device. The radar device is used in vehicles in order, for example, to carry out distance measurements to other road users. The radar device can be located in the region of bumpers. Furthermore, the radome 20 is usually visible on the vehicle from the outside. The radome 20 also protects the electronics unit of the radar device. The radome 20 is also heatable in order to prevent water from freezing on the radome 20 and, thus, corrupting a distance measurement. The radome 20 can be heated using the heating unit 19 shown in FIGS. 7 and 8.

The method disclosed herein includes the manufacture of the pre-molding 1, which has at least one contact element 2, 3. During the manufacture of the pre-molding 1, the at least one contact element 2, 3 is least partially overmolded with a plastic 4.

In the exemplary embodiment shown in FIG. 1, and also in the following exemplary embodiments, the pre-molding 1 has two contact elements 2, 3. When the pre-molding 1 is formed, two contact elements 2, 3 are therefore at least partially overmolded with the plastic 4. This is advantageous since the heating unit 19 can be a heating wire, and so the two contact elements 2, 3 enable an electrical current to be conducted through the heating unit 19 order to heat the radome 20. The two contact elements 2, 3 can be identical to each other and/or at least have the same features, even when the two contact elements 2, 3 are different from one another.

The at least one contact element 2, 3 includes at least one retaining extension 7, 8. According to the present exemplary embodiment, the at least one contact element 2, 3 has two retaining extensions 7, 8. Since two contact elements 2, 3 are shown, each of the two contact elements 2, 3 has two retaining extensions 7, 8. The first contact element 2 has the two retaining extensions 7a, 8a and the second contact element 3 has two retaining extensions 7b, 8b. By means of the at least one retaining extension 7, 8, the contact element 2, 3 can be retained in an injection mold 5, 6, as is shown in one of the following figures. Moreover, the at least one retaining extension 7, 8 protrudes beyond the inner face 15. The at least one retaining extension 7, 8 extends over the inner face 15. The at least one retaining extension 7, 8 is at least partially overmolded with the plastic 4.

Furthermore, the at least one contact element 2, 3 has a connection region 10a, 10b. Since two contact elements 2, 3 are shown in this exemplary embodiment of FIG. 1, each of the two contact elements 2, 3 has one connection region 10a, 10b. By means of the connection region 10a, 10b, an electrical contact can be established in order to supply the heating unit 19 with electrical energy, which heating unit is described below. As is apparent in FIG. 1, the connection region 10a, 10b is not covered by the plastic 4. In the manufacturing method, the at least one contact element 2, 3 is overmolded such that the connection region 10a, 10b remains free of plastic 4. As a result, the connection region 10a, 10b does not need to be freed of the plastic 4, or exposed, afterwards.

Features that have already been described with reference to the at least one preceding figure are not explained once more, for the sake of simplicity. Moreover, features can also be described first in this figure or in at least one of the following figures. Moreover, identical reference characters are utilized for identical features for the sake of simplicity. In addition, for the sake of clarity, not all the features may be shown and/or labeled with a reference character in the following figures. Features shown in one or several of the preceding figures can also be present in this figure or in one or several of the following figures, however. Moreover, for the sake of clarity, features can also be shown and/or labeled with a reference character first in this figure or in one or several of the following figures. Nevertheless, features that are first shown in one or several of the following figures can also be already present in this figure or in a preceding figure.

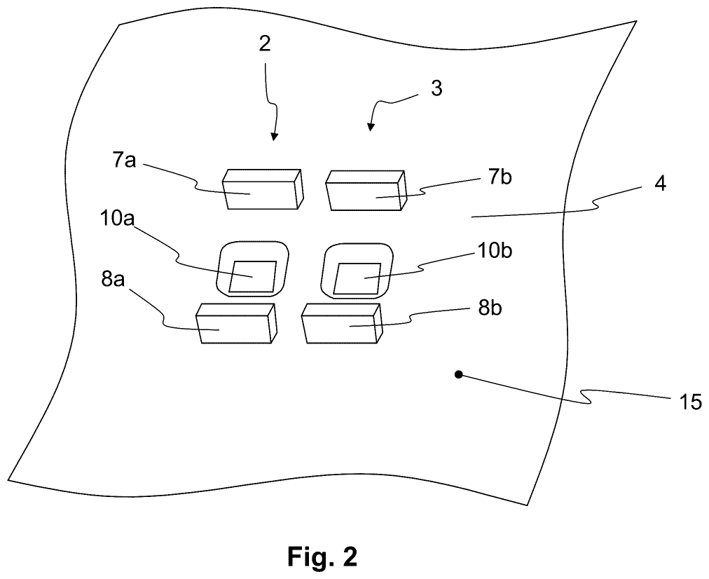

FIG. 2 shows a perspective, detailed view of the two contact elements 2, 3 shown in FIG. 1. The retaining extensions 7, 8 of the two contact elements 2, 3 protrude out of, or beyond, the plastic 4 and/or the inner face 15. Moreover, it is apparent that the connection regions 10a, 10b are exposed and/or not covered by plastic 4. The connection regions 10a, 10b have not been post-processed in the sense that the plastic 4 has been removed. The at least one, in particular both, contact element(s) 2, 3 is/are overmolded such that the connection region(s) 10a, 10b remain(s) free and/or is/are not covered by the plastic 4.

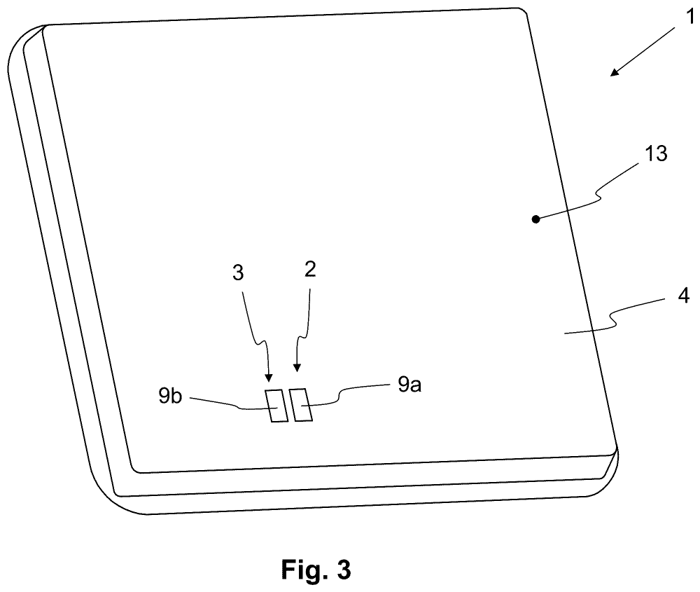

FIG. 3 shows a perspective view of an outer face 13 of a pre-molding 1. The outer face 13 and the inner face 15, which is shown in FIGS. 1 and 2, are arranged on the two opposite sides of the pre-molding 1. Moreover, the two contact elements 2, 3 are apparent here. The contact elements 2, 3, or the at least one contact element 2, 3, extend(s) through the plastic 4 and/or to the outer face 13. In FIGS. 1 and 2, the contact elements 2, 3, or the at least one contact element 2, 3, extend(s) through the plastic 4 and/or to the inner face 15.

The at least one contact element 2, 3, or both contact elements 2, 3, is/are overmolded with the plastic 4 such that a contact region 9a, 9b remains free of the plastic 4. According to the present exemplary embodiment, two contact elements 2, 3 are shown in FIG. 3, each contact element 2, 3 having one contact region 9a, 9b. By means of the at least one contact region 9a, 9b, the heating unit 19 can be contacted, so that electrical energy can be supplied to the heating unit 19. By means of the two contact regions 9a, 9b shown in FIG. 3, a circuit can be formed, which conducts current through the heating unit 19.

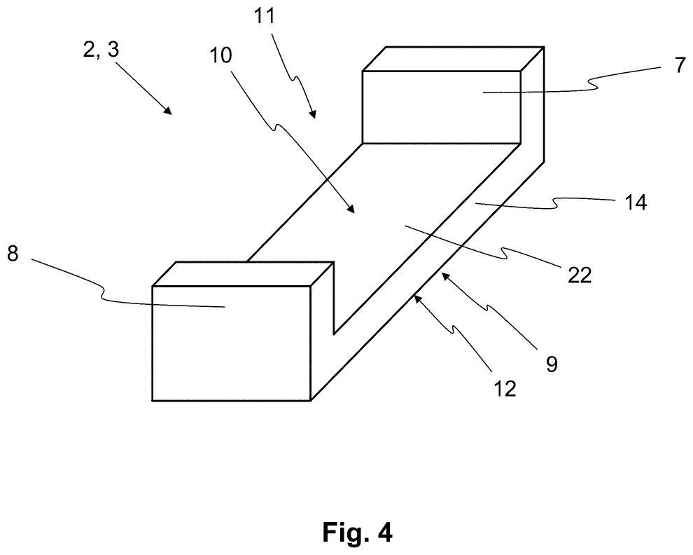

FIG. 4 shows a perspective view of the contact element 2, 3. As mentioned above, when two contact elements 2, 3 are present, they can be identical. For example, the at least one contact element 2, 3 can be a punched and/or bent part. As a punched and/or bent part, the contact element 2, 3 can have rounded edges. The contact element 2, 3 is advantageously electrically conductive.

As is also apparent in FIG. 4, the contact element 2, 3 is U-shaped. A center section 22 extends between the two retaining extensions 7, 8, which are apparent in FIG. 1.

Moreover, the contact element 2, 3 has an inner element face 11 and an outer element face 12. The inner element face 11 and/or the center section 22 has the connection region 10. The outer element face 12 and/or the center section 22 has the contact region 9.

Furthermore, the contact element 2, 3 has a peripheral element face 14. The plastic 4 is molded onto at least a portion of the peripheral element face 14. It is advantageous when the plastic 4 is molded onto the entire peripheral element face 14. The entire peripheral element face 14 is therefore connected to the plastic 4. Only the regions of the retaining extension 7, 8 or of the retaining extensions 7, 8 that protrude from the plastic 4, or beyond the inner face 15, remain free.

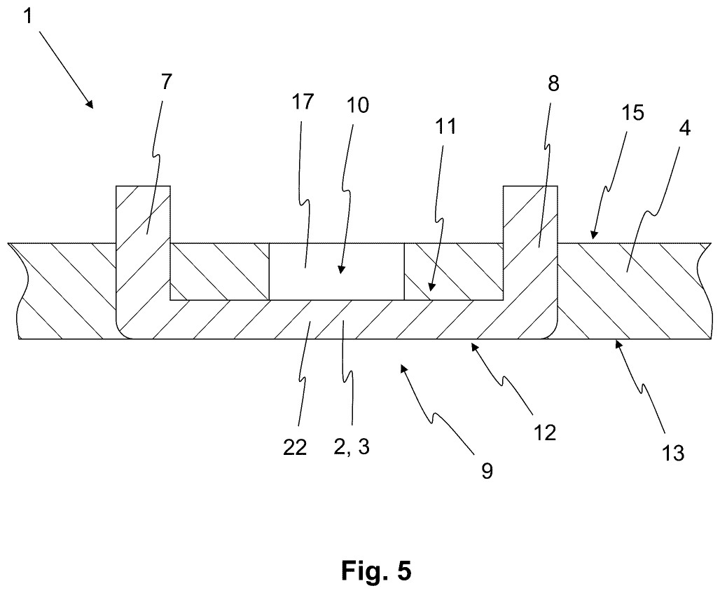

FIG. 5 shows a cross-section through the pre-molding 1 and through the contact element 2, 3, or through one of the two contact elements 2, 3 shown in FIGS. 1 and 2.

The retaining extensions 7, 8 protrude out of the plastic 4 and/or protrude beyond the inner face 15.

Moreover, the at least one contact element 2, 3 is overmolded such that the outer element face 12 and/or the contact region 9 is level with the outer face 13 of the plastic 4 and/or of the pre-molding 1.

Moreover, the at least one contact element 2, 3 is overmolded such that a recess 17 is formed on the inner face 15, in which recess the connection region 10 is located. The recess 17 remains free of plastic 4, or is a plastic-free region, so that an electrical contact can be established with the connection region 10. In the regions next to the recess 17, the inner element face 11 is overmolded with plastic 4. As a result, the at least one contact element 2, 3 is fixedly arranged in the plastic 4.

As is also apparent in FIG. 5, the retaining extensions 7, 8, or the at least one retaining extension 7, 8, are also at least partially overmolded with the plastic 4. As a result, a stable connection is formed between the at least one contact element 2, 3 and the plastic 4.

As is also apparent in FIG. 5, the at least one contact element 2, 3 is a bent part. This is apparent by virtue of the fact that the corners between the contact region 9 and the outer face 13 are rounded.

It is also apparent in the embodiment shown in FIG. 5 that the at least one contact element 2, 3 is U-shaped.

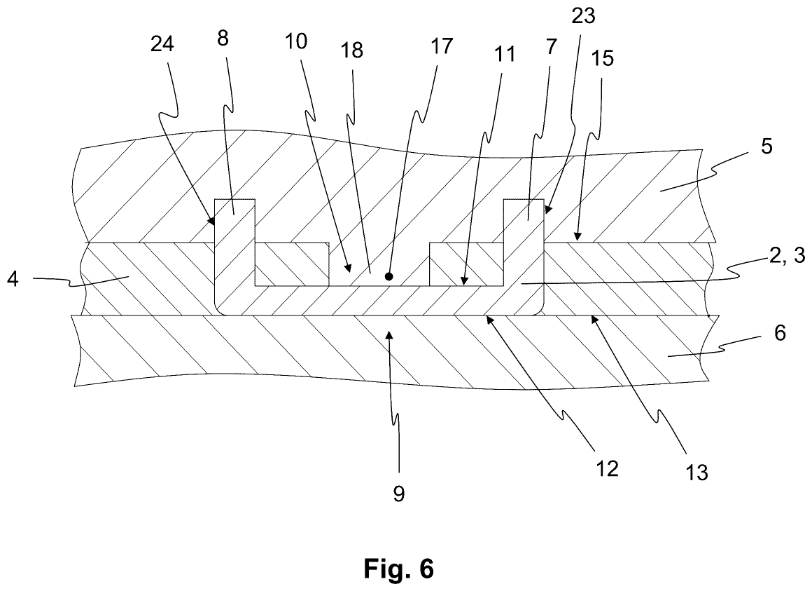

FIG. 6 shows a cross-section through the pre-molding 1 and the contact element 2, 3 and two injection molds 5, 6. In the manufacturing method, first, the at least one contact element 2, 3 can be placed and/or arranged in the first injection mold 5.

For this purpose, the at least one retaining extension 7, 8 can be placed and/or arranged in at least one receptacle 23, 24 in the first injection mold 5. As is apparent in FIG. 6, two receptacles 23, 24 are present, since two retaining extensions 7, 8 are also present. As a result, the at least one contact element 2, 3 is retained in the first injection mold 5. The first injection mold 5 can advantageously include a punch 18, which extends to the inner element face 11. As a result, the recess 17 and/or the connection region 10 remains free of the plastic 4. In the regions next to the punch 18, the at least one contact element 2, 3 is overmolded with the plastic 4. Additionally or alternatively, the retaining extensions 7, 8 are also overmolded with the plastic 4. The regions, in particular the ends of the retaining extensions 7, 8, which are arranged in the receptacles 23, 24 remain free of the plastic 4. Of course, when there is only one retaining extension 7, 8, only the end of the retaining extension remains free of the plastic 4.

Once the at least one contact element 2, 3 has been placed into the injection mold 5, the second injection mold 6 can be positioned relative to the first injection mold 5 and/or the at least one contact element 2, 3. The second injection mold 6 is positioned such that it abuts the outer element face 12 and/or the contact region 9. As a result, the plastic 4 is prevented from reaching the contact region 9. The contact region 9 therefore remains free of plastic 4.

The arrangement of the first and/or the second injection mold(s) 5, 6 shown in FIG. 6 ensures that the pre-molding 1 can be directly further processed. In particular, a post-processing of the connection region 10 and of the contact region 9 can be dispensed with or is otherwise unnecessary. In particular, plastic 4 does not need to be removed these regions.

FIG. 7 shows a perspective view of the outer face 13 of a pre-molding 1, on which a heating unit 19 is located. In this exemplary embodiment, the pre-molding 1 also includes two contact elements 2, 3, as is apparent in FIG. 7.

Moreover, each of the two contact elements 2, 3 has a contact region 9a, 9b. Since two contact elements 2, 3 are shown in FIG. 7, each of the two contact elements 2, 3 also has a connection region 10a, 10b, which are not shown in this view.

Moreover, the heating unit 19 is shown in FIG. 7, by means of which the radome 20 and/or the pre-molding 1 can be heated. As a result, ice, which corrupts the radar measurement, can be prevented from forming on the radome 20. This is important for vehicles in particular when a distance to other vehicles and/or to obstacles is measured.

As is also apparent in the embodiment shown in FIG. 7, the heating unit 19 includes a heating wire, or the heating unit 19 is a heating wire. Once the pre-molding 1 has been formed, the heating unit 19 is arranged on the pre-molding 1 and/or on the outer face 13.

Since the heating unit 19 is a heating wire in this embodiment, the heating wire is placed down in a meandering pattern. The heating wire is placed on the outer face 13 by a guiding mechanism (not shown here), in that the guiding mechanism moves along this meandering pattern. The heating wire is not placed down all at once, but rather successively, i.e., gradually along the thick line shown in FIG. 7.

While the heating wire is being placed down, the heating wire can be simultaneously embedded in the pre-molding 1, in the outer face 13, and/or in the plastic 4. This can be carried out, for example, by means of ultrasonic welding. While being placed down, the heating wire can be welded into the plastic 4 by means of the ultrasonic welding. As a result, a fixed connection is established between the heating unit 19 and the pre-molding 1.

In order to supply the heating unit 19 with electrical energy, which heating unit is a heating wire in this case, the heating unit 19 is also placed over the at least one contact element 2, 3.

Since two contact elements 2, 3 are shown in FIG. 7 and the heating unit 19 is a heating wire, a first end 25 and a second end 26 of the heating wire are placed over the respective contact elements 2, 3. The heating unit 19 is then contacted with the at least one contact element, or with both contact elements 2, 3. This can be carried out, for example, by means of thermocompression welding and/or resistance welding. In so doing, a contact unit of the heating unit 19 is contacted, in general, with the at least one contact element 2, 3. The contact unit of the heating unit 19 is formed by the two ends 25, 26 in this case.

The heating wire is placed down, according to the present exemplary embodiment, over the contact elements 2, 3 such that the heating wire is located ahead of and behind the corresponding contact element 2, 3. As a result, the heating wire is also embedded and/or welded in the plastic 4 ahead of and behind the corresponding contact element 2, 3, so that the heating wire is connected to the plastic 4 in a stable manner.

FIG. 8 shows a cross-section through the pre-molding 1, the two contact elements 2, 3, the heating unit 19, and a protective casing 21. The radome 20 is shown here, which radome is used in radar devices for vehicles, i.e., in vehicle radar devices, as a cover.

Once the heating unit 19 has been arranged on and/or connected to the pre-molding 1, the pre-molding 1 and the heating unit 19 are overmolded with the protective casing 21. The outer face 13 of the pre-molding 1 is overmolded. This can be carried out using an injection molding process. The protective casing 21 can also be made of a plastic 4. The protective casing 21 can be made of the same plastic 4 as the pre-molding 1. Alternatively, the protective casing 21 can also be made of another plastic 4.

As is also apparent in FIG. 8, the heating unit 19, or the heating wire shown, is at least partially embedded in the pre-molding 1 and/or in the plastic 4. As is apparent in the illustrated embodiment, one-half of the heating unit 19, or the heating wire, is embedded in the pre-molding 1 and/or in the plastic 4. The heating unit 19, or the heating wire, can also be completely embedded in the pre-molding 1 and/or in the plastic 4. As a result, the outer face 13 forms a planar surface and/or the heating unit 19, or the heating wire shown, does not protrude beyond the outer face 13.

As is apparent in the cross-section of FIG. 8, the connection regions 10a, 10b are free of plastic 4. Connecting contacts or connecting pins can be arranged on the connection regions 10a, 10b in order to supply the heating unit 19 with electrical energy. The contact element 2, 3 therefore has electrical conductivity. The contact element 2, 3 conducts the current from the connection region 10a, 10b to the contact region 9a, 9b.

### LIST OF REFERENCE CHARACTERS

1 pre-molding

2 first contact element

3 second contact element

4 plastic

5 first injection mold

6 second injection mold

7 first retaining extension

8 second retaining extension

9 contact region

10 connection region

11 inner element face

12 outer element face

13 outer face

14 peripheral element face

15 inner face

17 recess

18 punch

19 heating unit

20 radome

21 protective casing

22 center section

23 first receptacle

24 second receptacle

25 first end

26 second end

1-27. (canceled)

28. A method for manufacturing a pre-molding and/or a radome for radar devices for vehicles, the method comprising:
forming a pre-molding having at least one contact element for electrically contacting a heating unit for heating the radome,
wherein, when forming the pre-molding, the at least one contact element is at least partially overmolded with plastic.

29. The method of claim 28, wherein forming the pre-molding comprises overmolding the at least one contact element such that it extends from an outer face of the pre-molding to an inner face of the pre-molding.

30. The method of claim 28, further comprising interlockingly placing the at least one contact element into a first injection mold.

31. The method of claim 30, wherein interlockingly placing the at least one contact element into the first injection mold comprises arranging at least one retaining extension of the at least one contact element in at least one recess provided therefor in the first injection mold.

32. The method of claim 28, wherein the pre-molding is formed by a plastic and wherein forming the pre-molding comprises overmolding the at least one contact element such that at least one contact region and/or at least one connection region of the at least one contact element remains free, at least in some areas, of the plastic.

33. The method of claim 32, wherein overmolding the at least one contact element comprises overmolding the at least one contact element such that an inner element face of the at least one contact element is overmolded at least in some areas, wherein the inner element face includes the at least one connection region.

34. The method of claim 33, wherein overmolding the at least one contact element comprises overmolding the at least one contact element such that, on the inner element face at a location between two retaining extensions of the at least one contact, a recess is formed in the plastic so that the at least some areas of the at least one connection region remain free of the plastic.

35. The method of claim 33, wherein overmolding the at least one contact element comprises overmolding the at least one contact element such that a retaining extension of the at least one contact element extends away from the inner element face and extends out of the pre-molding.

36. The method of claim 33, wherein overmolding the at least one contact element comprises overmolding the at least one contact element such that such that the at least one contact element is interlockingly connected to the pre-molding at least on the inner element face.

37. The method of claim 32, wherein overmolding the at least one contact element comprises overmolding the at least one contact element such that an outer element face of the at least one contact element remains free of the plastic at least in some areas, wherein the outer element face includes the at least one contact region.

38. The method of claim 32, further comprising placing an injection mold flat on the at least one contact region during the overmolding.

39. The method of claim 32, wherein overmolding the at least one contact element comprises overmolding the at least one contact element with the plastic such that an outer face of the pre-molding and the at least one contact region form a level surface and/or a smooth and/or stepless transition.

40. The method of claim 32, wherein overmolding the at least one contact element comprises overmolding the at least one contact element such that the plastic is injected at least partially onto a peripheral element face of the at least one contact element.

41. The method of claim 32, wherein overmolding the at least one contact element comprises overmolding the at least one contact element such that an inner face of the pre-molding, which is located on a side of the pre-molding facing away from an outer face of the pre-molding, and the at least one connection region are spaced apart from one another, wherein the at least one connection region is offset relative to the inner face.

42. The method of claim 28, further comprising arranging a heating wire for heating the radome on an outer face of the pre-molding.

43. The method of claim 42, wherein arranging the heating wire comprises arranging the heating wire relative to the at least one contact element such that the heating wire is contacted with the two contact regions of the at least one contact element, the two contact regions being electrically insulated from each other.

44. The method of 42, wherein arranging the heating wire comprises embedding the heating wire in the pre-molding using ultrasonic welding.

45. The method of 42, wherein arranging the heating wire comprises arranging the heating wire relative to the at least one contact element such that the heating wire is in contact with at least one connection region of the at least one contact using thermocompression welding.

46. The method of claim 42, further comprising overmolding the pre-molding and the heating wire such that the pre-molding and the heating wire are surrounded by a protective casing.

47. The method of claim 42, wherein arranging the heating wire comprises arranging the heating wire after overmolding of the at least one contact with plastic, further comprising connecting the heating wire to the pre-molding after arranging the heating were thereon, contacting the heating wire with the at least one contact element after connecting the heating wire to the pre-molding, and subsequently overmolding the pre-molding and the heating wire with a protective casing.
